(19) United States
(12) Patent Application Publication
(10) Pub. No.: US 2025/0222601 A1
(43) Pub. Date: Jul. 10, 2025

(54) APPARATUS FOR MOVING HEAVY WELDMENT AND METHOD OF USE

(71) Applicant: Morgan Engineering Systems, Inc., Alliance, OH (US)

(72) Inventors: Mark Len FEDOR, Hartville, OH (US); Kenneth Dean MAURER, Canton, OH (US); Scott Alan ZILKE, Berlin Center, OH (US)

(73) Assignee: Morgan Engineering Systems, Inc., Alliance, OH (US)

(21) Appl. No.: 18/408,924

(22) Filed: Jan. 10, 2024

(51) Int. Cl. B25J 18/04; B25J 11/00; B25J 15/00; B25J 17/02

(52) U.S. Cl. CPC B25J 18/04; B25J 15/0095; B25J 11/008; B25J 15/0052; B25J 17/0241

(57) ABSTRACT

A system for moving a heavy weldment. The system includes at least a set of first manipulators that is longitudinally aligned and spaced apart along a central axis, and a set of second manipulators that is longitudinally aligned and spaced apart along the central axis and is transversely opposite to the set of first manipulators relative to the central axis. Each manipulator of the set of first manipulators and the set of second manipulators includes a base that operably engages with a ground surface, and a pivot frame that rotatably engages with the base between a seated position and a raised position, wherein the pivot frame is configured to hold and move the heavy weldment about the central axis.

### TECHNICAL FIELD

This disclosure is directed to an apparatus or a system of apparatuses for moving a heavy weldment between a first position and a second position.

### BACKGROUND ART

Girders, beams, and other similar heavy weldments are the primary or main horizontal support of a structure that supports other smaller or lights beams. Generally, these girders are used to construct and provide support for bridges, large commercial buildings, and other expansive structures at major concentric loads such as columns or beam reactions. Girders can also be made from various building materials as dictated by the implementation of particular heavy weldments. In one instance, girders could be constructed and/or made of stainless steel and other similar metals that are equipped to support major vertical loads. However, in some cases, girders may need to be constructed of multiple pieces given the implementation of these girders.

To combat this issue, manufacturers of these stainless steel or metal girders must connect and/or attach these pieces together to construct the girders. In one instance, manufacturers of these types of girders may perform numerous welds along the length of the girders to ensure that the pieces (e.g., webs, top and bottom flanges, web stiffeners, etc.) are connected with one another to form these girders. However, constructing these girders through welding operations or similar construction operations may become extremely difficult given the sheer size, weight, and configuration of a given girder. In one instance, manufacturers may need to assembly and construct these girders in sections or portions (if possible) in order to access all side and/or ends of these girders to perform welding operations. In another instance, manufacturers of the girders may need to have extensive equipment and/or vehicles on hand to move and/or manipulate the girder during this construction process that would be integrated into a manufacturing plant or building. In these instances, however, these techniques may require extensive time and labor in order to assemble and construct these types of girders.

### SUMMARY OF THE INVENTION

In one aspect, an exemplary embodiment of the present disclosure may provide a system for moving a heavy weldment. The system includes a set of first manipulators that is longitudinally aligned and spaced apart along a central axis, and a set of second manipulators that is longitudinally aligned and spaced apart along the central axis and is transversely opposite to the set of first manipulators relative to the central axis. Each manipulator of the set of first manipulators and the set of second manipulators comprises a base that operably engages with a ground surface, and a pivot frame that rotatably engages with the base between a seated position and a raised position, wherein the pivot frame is configured to hold and move the heavy weldment about the central axis.

This exemplary embodiment or another exemplary embodiment may further include that the pivot frame of each manipulator of the set of first manipulators and the set of second manipulators further comprises: a pivot bar; a first engagement structure operably engaged with the pivot bar; and a second engagement structure operably engaged with the first engagement structure; wherein one or both of the first engagement structure and the second engagement structure cooperatively holds the heavy weldment. This exemplary embodiment or another exemplary embodiment may further include that the pivot frame of each manipulator of the set of first manipulators and the set of second manipulators further comprises: a first end of the first engagement structure; a second end of the first engagement structure opposite to the first end and engaging with the pivot bar; and a first inner surface of the first engagement structure extending between the first end and the second end. This exemplary embodiment or another exemplary embodiment may further include that the pivot frame of each manipulator of the set of first manipulators and the set of second manipulators further comprises: a first end of the second engagement structure; a second end of the second engagement structure opposite to the first end and engaging with the first engagement structure; and a second inner surface of the second engagement structure extending between the first end and the second end; wherein the first inner surface and the second inner surface engage with the heavy weldment and are orthogonal to one another. This exemplary embodiment or another exemplary embodiment may further include that when the pivot frame of each manipulator of one or both of the set of first manipulators and the set of second manipulators is provided in the seated position, the second inner surface is positioned vertically above the first inner surface. This exemplary embodiment or another exemplary embodiment may further include that when the pivot frame of each manipulator of one or both of the set of first manipulators and the set of second manipulators is provided in the raised position, the first inner surface is positioned vertically above the second inner surface. This exemplary embodiment or another exemplary embodiment may further include that when the pivot frame of each manipulator of the set of first manipulators and the set of second manipulators is provided in the raised position, the second inner surfaces of the set of first manipulators and the set of second manipulators are substantially parallel with one another. This exemplary embodiment or another exemplary embodiment may further include that each manipulator of the set of first manipulators and the set of second manipulators further comprises: at least one pivoting actuator operably engaged with the base and the pivot frame for rotating the pivot frame from the seated position to the raised position. This exemplary embodiment or another exemplary embodiment may further include that the pivot frame of each manipulator of the set of first manipulators and the set of second manipulators further comprises: at least one tubular support of the first engagement structure that is spaced apart from the pivot bar and engages with the at least one pivoting actuator; wherein the at least one pivoting actuator is configured to rotate the pivot frame at the at least one tubular support. This exemplary embodiment or another exemplary embodiment may further include that the base of each manipulator of the set of first manipulators and the set of second manipulators further comprises: at least one projection operably engages with the base and the at least one pivoting actuator and is positioned below the base and the pivot frame. This exemplary embodiment or another exemplary embodiment may further include that each manipulator of the set of first manipulators and the set of second manipulators further comprises: at least one transfer actuator operably engaged with the pivot frame; wherein the at least one transfer actuator is configured to linear move the heavy weldment. This exemplary embodiment or another exemplary embodiment may further include that each manipulator of the set of first manipulators and the set of second manipulators further comprises at least one extension provided with the pivot frame; at least one pivot mount provided with the base; and at least one linkage pin connecting the at least one extension and the at least one pivot mount with one another to rotate the pivot frame relative to the base. This exemplary embodiment or another exemplary embodiment may further include that the set of first manipulators and the second set of manipulators are longitudinally offset to one another.

In another aspect, an exemplary embodiment of the present disclosure may provide a method. The method includes steps of: engaging a first web of a heavy weldment with a first set of manipulators; actuating each manipulator of the set of first manipulators from a first seated position to a first raised position; actuating each manipulator of a set of second manipulators from a second seated position to a second raised position; moving the heavy weldment from the set of first manipulators to the set of second manipulators; disengaging the first web of the heavy weldment from the first set of manipulators; engaging a second web of the heavy weldment with the set of second manipulators, wherein the second web faces in an opposite direction relative to the first web; and actuating each manipulator of the set of second manipulators from the second raised position to the second seated position.

This exemplary embodiment or another exemplary embodiment may further include that the step of disengaging the first web of the heavy weldment from the first set of manipulator further includes; pressing against the first web of the heavy weldment, by at least one transfer actuator provide with each manipulator of the first set of manipulators, until the second web of the heavy weldment is engaged with the set of second manipulators. This exemplary embodiment or another exemplary embodiment may further include that the step of actuating each manipulator of the set of first manipulators from the first seated position to the first raised position further includes: rotating each manipulator of the set of first manipulators in a first direction from the first seated position to the first raised position; and wherein the step of actuating each manipulator of the set of second manipulators from the second seated position to the second raised position further includes: rotating each manipulator of the set of second manipulators in a second direction from the second seated position to the second raised position towards the first set of manipulators. This exemplary embodiment or another exemplary embodiment may further include that the step of engaging the first web of the heavy weldment with the first set of manipulators further includes: engaging the first web of the heavy weldment with a first engagement structure of a pivot frame of each manipulator of the set of first manipulators; and engaging at least one flange of the heavy weldment with a second engagement structure of the pivot frame of each manipulator of the set of first manipulators; wherein the first engagement structure and the second engagement structure are substantially orthogonal to the one another. This exemplary embodiment or another exemplary embodiment may further include that the step of engaging the second web of the heavy weldment with the second set of manipulators further includes: engaging the second web of the heavy weldment with a first engagement structure of a pivot frame of each manipulator of the set of second manipulators; and engaging the at least one flange of the heavy weldment on a second engagement structure of the pivot frame of each manipulator of the set of second manipulators; wherein the first engagement structure and the second engagement structure are substantially orthogonal to the one another; wherein the first engagement structure of the pivot frame of each manipulator of the set of first manipulators and the set of second manipulators are substantially parallel with one another in the first and second seated positions. This exemplary embodiment or another exemplary embodiment may further include steps of defining a continuous surface between the second engagement structure of the pivot frame of each manipulator of the set of first manipulators and the second engagement structure of the pivot frame of each manipulator of the set of second manipulators; and sliding the at least one flange of the heavy weldment along the continuous surface. This exemplary embodiment or another exemplary embodiment may further include a step of offsetting the set of first manipulators and the set of second manipulators with one another.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a top plan view of a manipulator system in accordance with one aspect of the present disclosure, wherein the manipulator system includes at least a set of first manipulators and a set of second manipulators.

FIG. 2 is a rear, top, first side isometric perspective view of a single manipulator.

FIG. 3 is a top plan view of the manipulator shown in FIG. 2.

FIG. 4 is a longitudinal section view taken in the direction of line 4-4 shown in FIG. 3.

FIG. 5 is an operational view of a heavy weldment loaded onto the set of first manipulators, wherein the set of first manipulators is provided in a first seated position and the second of second manipulators is provided in a second seated position.

FIG. 6A is the operational view from FIG. 5 but taken in the direction of line 6A-6A shown in FIG. 5.

FIG. 6B is another operational view similar to FIG. 6A, but each manipulator of the set of second manipulators is actuated from the second seated position to a second raised position.

FIG. 6C is another operational view similar to FIG. 6B, but each manipulator of the set of first manipulators is actuated from the first seated position towards a first raised position while loaded with the heavy weldment.

FIG. 6D is another operational view similar to FIG. 6C, but each manipulator of the set of first manipulators is provided at the first raised position while loaded with the heavy weldment.

FIG. 6E is another operational view similar to FIG. 6D, but a transfer actuator of each manipulator of the set of first manipulators moves the heavy weldment from the set of first manipulators to the set of second manipulators.

FIG. 6F is another operational view similar to FIG. 6E, but each manipulator of the set of second manipulators is actuated from the second raised position to the second seated position while loaded with the heavy weldment.

FIG. 6G is another operational view similar to FIG. 6F, but each manipulator of the set of first manipulators is actuated from the first raised position to the first seated position without being loaded with the heavy weldment.

FIG. 7 is a flowchart of a method.

Similar numbers refer to similar parts throughout the drawings.

### DETAILED DESCRIPTION

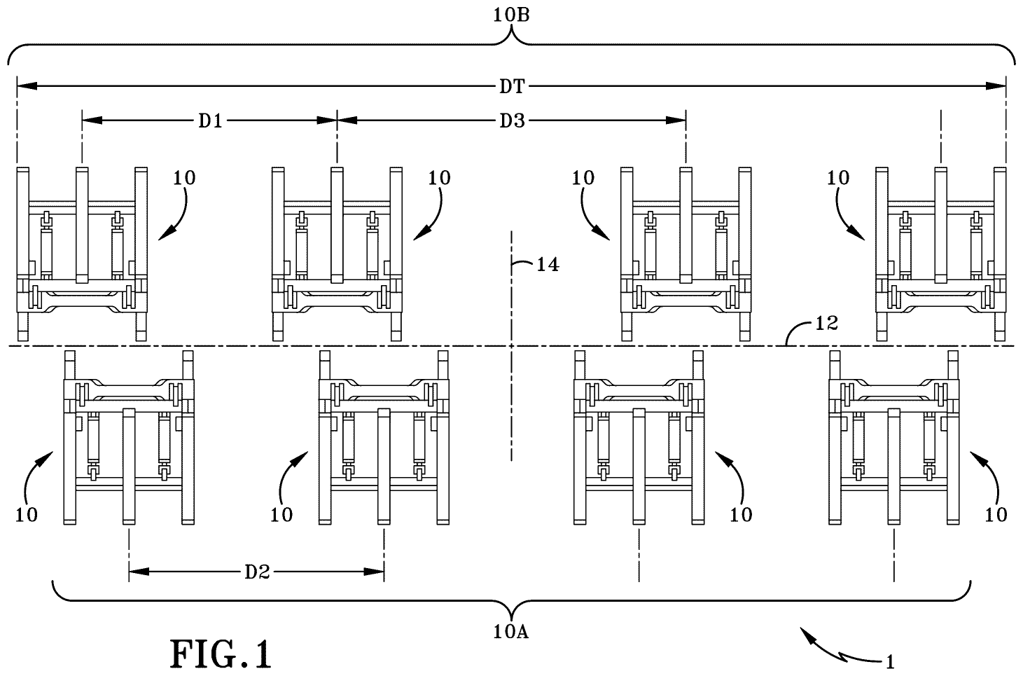

FIGS. 1 and 5-6G illustrate a heavy weldment or girder manipulator system (hereinafter “manipulator system”) generally referred to as 1. In operation, the manipulator system 1 is configured to move and/or rotate a heavy weldment or girder about a longitudinal axis of the heavy weldment so that operators or technicians can weld webs, top and bottom flanges, web stiffeners, and other components of the heavy weldment with one another at two opposing sides or positions. Stated differently, the manipulator system 1 allows operators or technicians to weld components of the heavy weldment at a first side or position and then flip or rotate the heavy weldment about the longitudinal axis of the heavy weldment so that the operators or technicians may weld components of the heavy weldment at a second side or position opposite to the first side. Such components and machines of the manipulator system 1 are now discussed in greater detail below.

Manipulator system 1 includes manipulators 10 that are configured to move and/or rotate a heavy weldment or girder about a longitudinal axis of the heavy weldment for welding operations. As best seen in FIG. 1, the manipulator system 1 includes a set of first manipulators 10A and a set of second manipulators 10B for moving and/or rotating a heavy weldment or girder about a longitudinal axis of the heavy weldment for welding operations. Referring to FIG. 1, the set of first manipulators 10A and the set of second manipulators 10B are aligned relative to a central axis 12 that divides and/or separates the set of first manipulators 10A and the set of second manipulators 10B from one another. In the present disclosure, the set of first manipulators 10A and the set of second manipulators 10B are transversely opposite to one another relative to a lateral or transverse axis 14 that intersects the central axis 12 (see FIG. 1). As discussed in greater detail below, the set of first manipulators 10A and the set of second manipulators 10B are configured to move and/or rotate a heavy weldment or girder about a longitudinal axis of the heavy weldment for welding operations.

In the present disclosure, the manipulator system 1 may be arranged in any suitable pattern so that the set of first manipulators 10A and the set of second manipulators 10B may transfer a heavy weldment between one another. In the present disclosure, the set of first manipulators 10A and the set of second manipulators 10B are longitudinally offset to one another along the central axis 12 so that a heavy weldment may be grasped and loaded onto less manipulators 10 in a given space. In one instance, a pair of manipulators 10 of the set of first manipulators 10A may be set a first distance from one another when measured between longitudinal axes 10C of the manipulators 10 (denoted by double arrows labeled “D1”), and another pair of manipulators 10 of the set of second manipulators 10B may be set at a second distance from one another when measured between longitudinal axes 10C of the manipulators 10 (denoted by double arrows labeled “D2”) where the second distance “D2” is equal with the first distance “D1.” In this same instance, yet another pair of manipulators of the set of second manipulators 10B may be set at a third distance from one another when measured between longitudinal axes 10C of the manipulators 10 (denoted by double arrows labeled “D3”) where the third distance “D3” is greater than the first distance “D1” and the second distance “D2” mentioned previously. In this same instance, an overall distance of the set of second manipulators 10D (denoted by double arrows labeled “DT”) may also be greater than an overall distance of the set of first manipulators 10A. Such distances and longitudinal offset between manipulators 10 of the manipulator system 1 maximize the number of manipulators that may be included in the set of first manipulators 10A and the set of second manipulators 10B to grasp and hold the heavy weldment at multiple position along a length of the heavy weldment while minimizing the overall footprint of the manipulator system 1.

It should be understood that the manipulators provided in the set of first manipulators 10A and the manipulators provided in the set of second manipulators 10B are substantially similar to one another and are orientated in a mirrored image relative to the central axis 12. For brevity, the features and descriptions of a manipulator 10 mentioned in detail below refer to the manipulators provided in the set of first manipulators 10A and the manipulators provided in the set of second manipulators 10B.

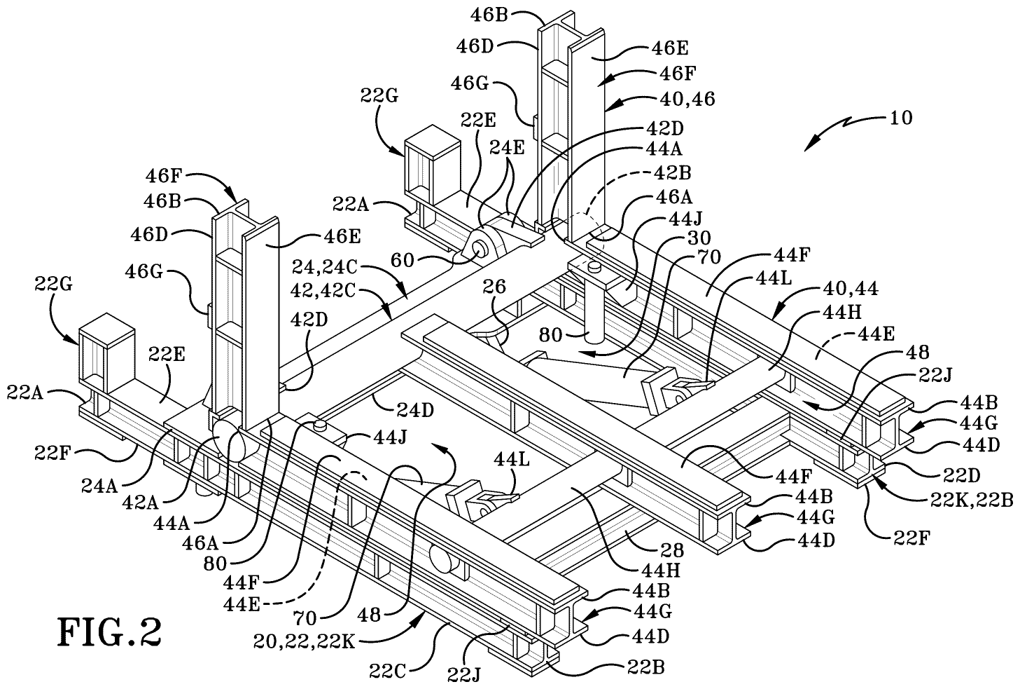

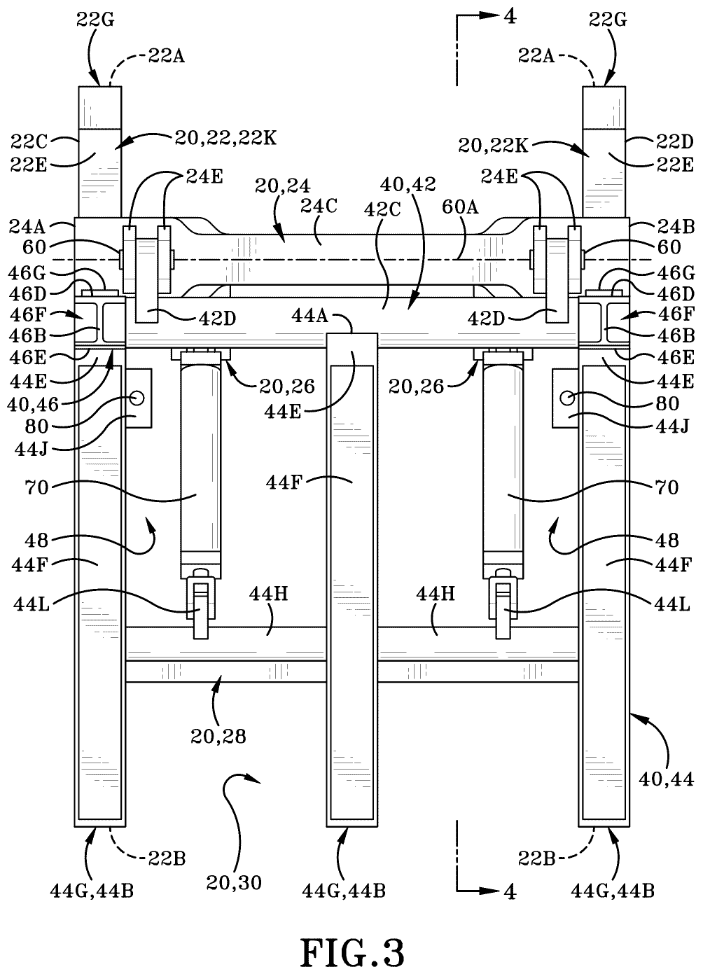

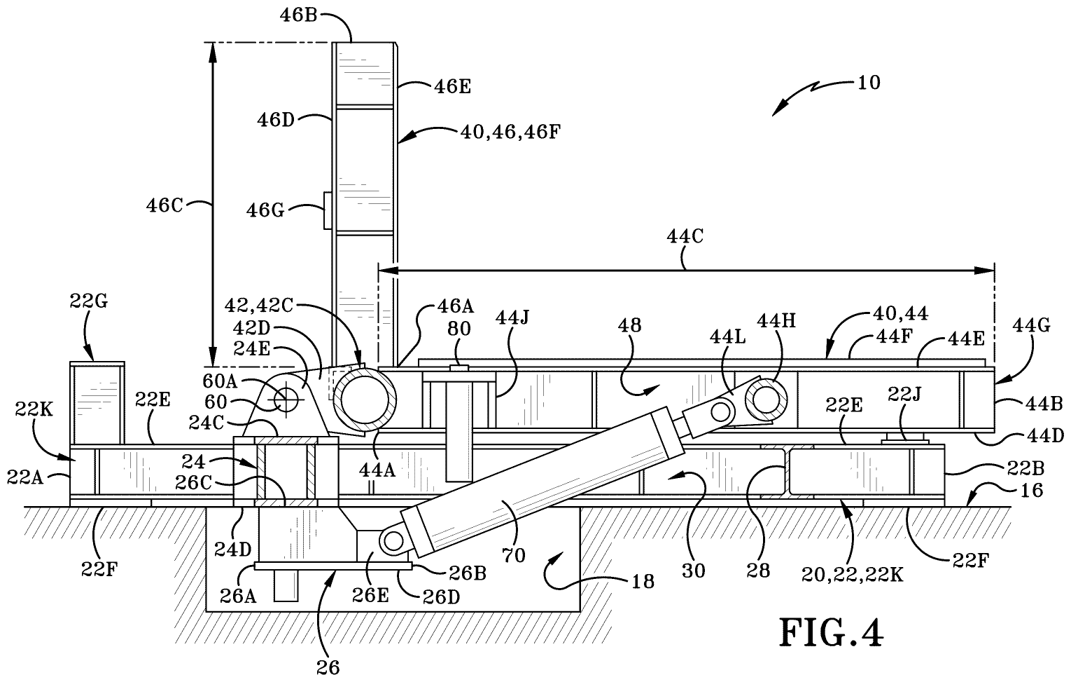

Manipulator 10 includes a base 20 that engages with a ground surface or support structure 16 (see FIG. 4) and may be partially housed inside of a recess or hole 18. As best seen in FIGS. 2 and 4, base 20 includes a chassis 22 having a first or front end 22A, a second or rear end 22B longitudinally opposite to the front end 22A, and a longitudinal direction extending therebetween. Chassis 22 also includes a first side 22C positioned between the front end 22A and the rear end 22B, a second side 22D positioned between the front end 22A and the rear end 22B and being transversely opposite to the first side 22C, and a transverse direction extending therebetween (see FIGS. 3-4). Chassis 22 also includes a top end or surface 22E that is positioned above the front end 22A, the rear end 22B, the first side 22C, and the second side 22D, a bottom end or surface 22F that is positioned below the front end 22A, the rear end 22B, the first side 22C, and the second side 22D and vertically opposite to the top end 22E, and a vertical direction extending therebetween.

Still referring to chassis 22, chassis 22 also includes a pair of upright supports 22G. As best seen in FIG. 2, each upright support of the pair of upright supports 22G extends upwardly from the top end 22E. In the present disclosure, a first upright support of the pair of upright supports 22G is positioned at the front end 22A of the chassis 22 and at the first side 22C of the chassis 22. In the present disclosure, a second upright support of the pair of upright supports 22G is positioned at the front end 22A of the chassis 22 and at the second side 22D of the chassis 22. As such, each upright support of the pair of upright supports 22G is transversely opposite to one another relative to the transverse direction of chassis 22. In operation, the pair of upright supports 22G stops and maintains a pivot frame of the manipulator 10 when the pivot frame is rotated from a seated position to a raised position relative to the base 20 during welding operations; such pivot frame of the manipulator 10 is discussed in greater detail below.

Still referring to chassis 22, chassis 22 may also include at least one stop 22J. As best seen in FIG. 2, chassis 22 includes a pair of stops 22J that extends upwardly from the top end 22E. In the present disclosure, a first stop of the pair of stops 22J is positioned at the rear end 22B of the chassis 22 and at the first side 22C of the chassis 22. In the present disclosure, a second stop of the pair of stops 22J is positioned at the rear end 22B of the chassis 22 and at the second side 22D of the chassis 22. As such, each stop of the pair of stops 22J is transversely opposite to one another relative to the transverse direction of chassis 22. In operation, the pair of stops 22J stops and maintains a pivot frame of the manipulator 10 when the pivot frame actuates from the raised position to the seated position relative to the base 20 during welding operations; such pivot frame of the manipulator 10 is discussed in greater detail below.

Still referring to chassis 22, chassis 22 may also be formed by a set of beams 22K that extends longitudinally between the front end 22A and the rear end 22B. As best seen in FIG. 2, a first beam of the set of beams 22K extends longitudinally between the front end 22A and the rear end 22B and is positioned at the first side 22C. Similarly, and as best seen in FIG. 1, a second beam of the set of beams 22K extends longitudinally between the front end 22A and the rear end 22B but is positioned at the second side 22D and is transversely opposite to the first beam of the set of beams 22K. In the present disclosure, the set of beams 22K also include the top end 22E and the bottom end 22F of the chassis 22. In the present disclosure, the first upright support of the pair of upright supports 22G is also provided with a first beam of the set of beams 22K at the front end 22A, and the second upright support of the pair of upright supports 22G is provided with a second beam of the set of beams 22K at the front end 22A.

Base 20 also includes a front cross member 24. As best seen in FIG. 3, front cross member 24 includes a first end 24A positioned at the first side 22C of the chassis 22 and operably engages with the first beam of the set of beams 22K, a second end 24B positioned at the second side 22D of the chassis 22, operably engages with the second beam of the set of beams 22K, and is longitudinally opposite to the first end 24A, and a longitudinal direction extending therebetween. Front cross member 24 also includes a top surface 24C that extends between and is positioned above the first end 24A and the second end 24B. Front cross member 24 also includes a bottom surface 24D that extends between and is positioned below the first end 24A and the second end 24B and is vertically below the top surface 24C.

Still referring to front cross member 24, front cross member 24 may also include at least pivot mount 24E. As best seen in FIG. 2, front cross member 24 includes a pair of pivot mounts 24E that extends upwardly from the top surface 24C. In the present disclosure, a first pivot mount of the pair of pivot mounts 24E is positioned at the first end 24A of the front cross member 24. In the present disclosure, a second pivot mount of the pair of pivot mounts 24E is positioned at the second end 24B of the front cross member 24. With such arrangement, each pivot mount of the pair of pivot mounts 24E is longitudinally opposite to one another relative to the longitudinal direction of front cross member 24. Each pivot mount of the pair of pivot mounts 24E is also configured to receive a pivot pin or linkage pin (see FIG. 4), which is discussed in greater detail below.

Base 20 also includes a pair of projections 26. As best seen in FIG. 4, each projection of the pair of projections 26 is spaced apart from one another along the cross member 24. In the present disclosure, a first projection of the pair of projections 26 is engaged at the first end 24A of the front cross member 24, and a second projection of the pair of projections 26 is engaged at the second end 24B of the front cross member 24. For brevity, the descriptions and features apply equally to each projection of the pair of projections 26.

In the present disclosure, each projection 26 operably engages with the front cross member 24 and is positioned below the chassis 22 and the front cross member 24. As best seen in FIG. 4, each projection 26 includes a front end 26A, a rear end 26B that is opposite to the front end 26A, a top end 26C that is positioned between the front end 26A and the rear end 26B and operably engages with the bottom surface 24D of front cross member 24, and a bottom end 26D that is positioned between the front end 26A and the rear end 26B and spaced apart from front cross member 24.

Still referring to projection 26, each projection 26 may also include an actuator mount 26E. As best seen in FIGS. 2 and 4, the actuator mount 26E is positioned between the front end 26A and the rear end 26B of each projection 26 with the actuator mount 26E being closer to the rear end 26B. The actuator mount 26E is also configured to receive a pivot pin or rod of a pivot actuator of the manipulator 10, which is discussed in greater detail below.

Base 20 may also include a rear cross member 28. As best seen in FIG. 2, a first end of the rear cross member 28 is positioned at the first side 22C of the chassis 22 and operably engages with the first beam of the set of beams 22K, a second end that is positioned at the second side 22D of the chassis 22, operably engages with the second beam of the set of beams 22K, and is longitudinally opposite to the first end, and a longitudinal direction extending therebetween. In the present disclosure, rear cross member 28 may provide lateral support at the rear end 22B of the chassis 22 between the first beam of the set of beams 22K and the second beam of the set of beams 22K.

Base 20 also defines a first central opening 30. As best seen in FIG. 2, first central opening 30 is collectively defined by the chassis 22, the front cross member 24, and the rear cross member 28. In operation, one or more pivot actuators of the manipulator 10 may pass through the first central opening 30 and engage with a pivot frame of the manipulator 10 for pivoting and/or actuating the pivot frame between a seated position and a raised position; the one or more pivot actuators and pivot frame of the manipulator 10 are discussed in greater detail below.

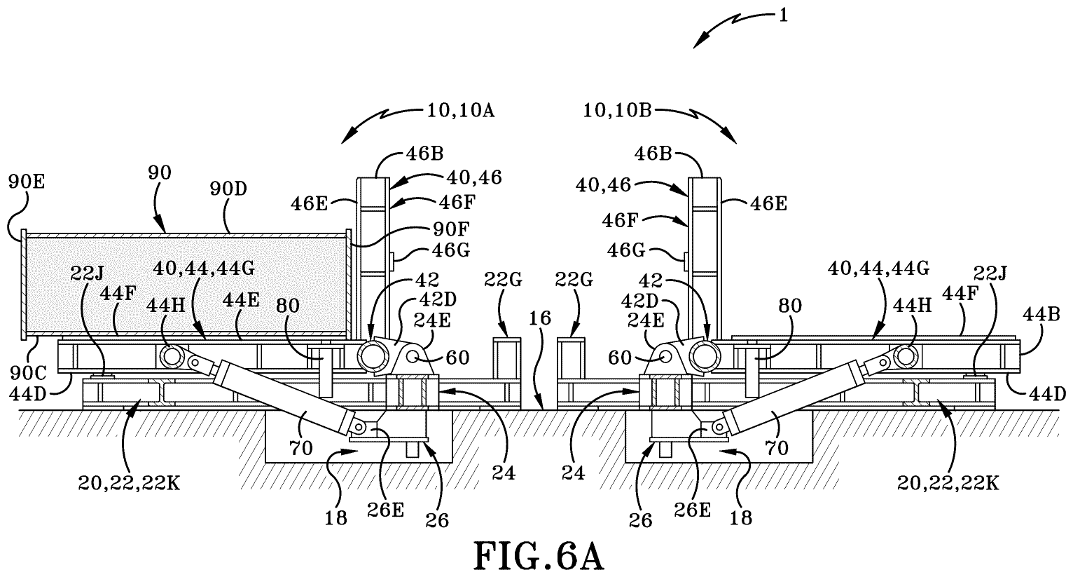

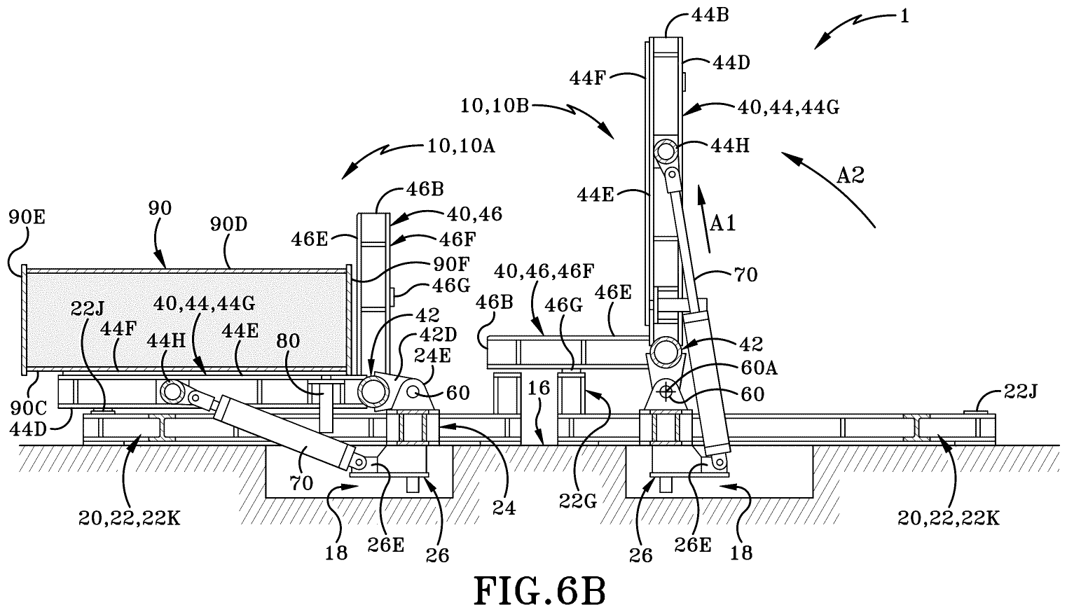

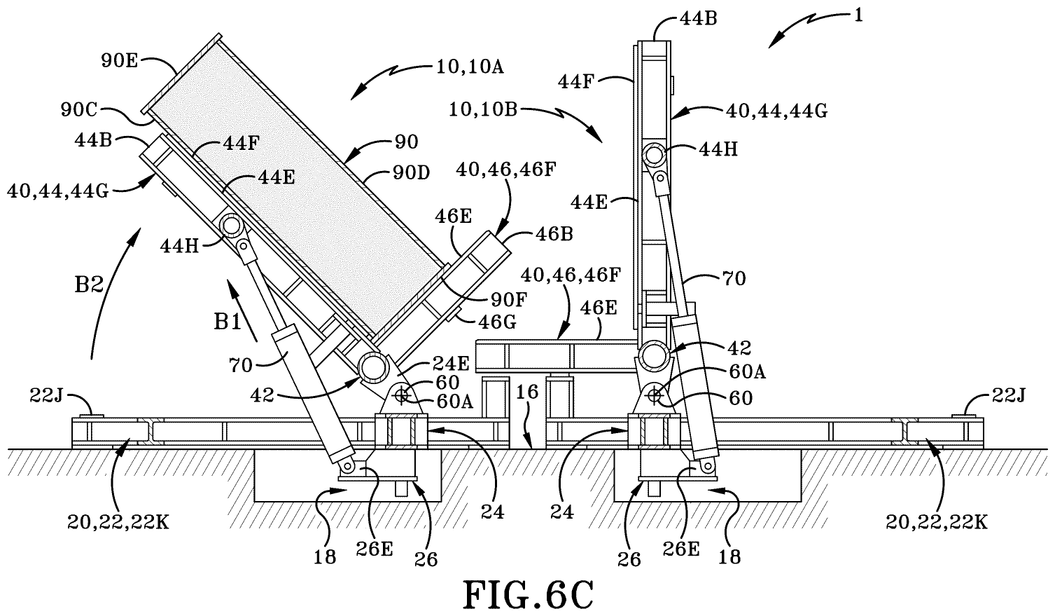

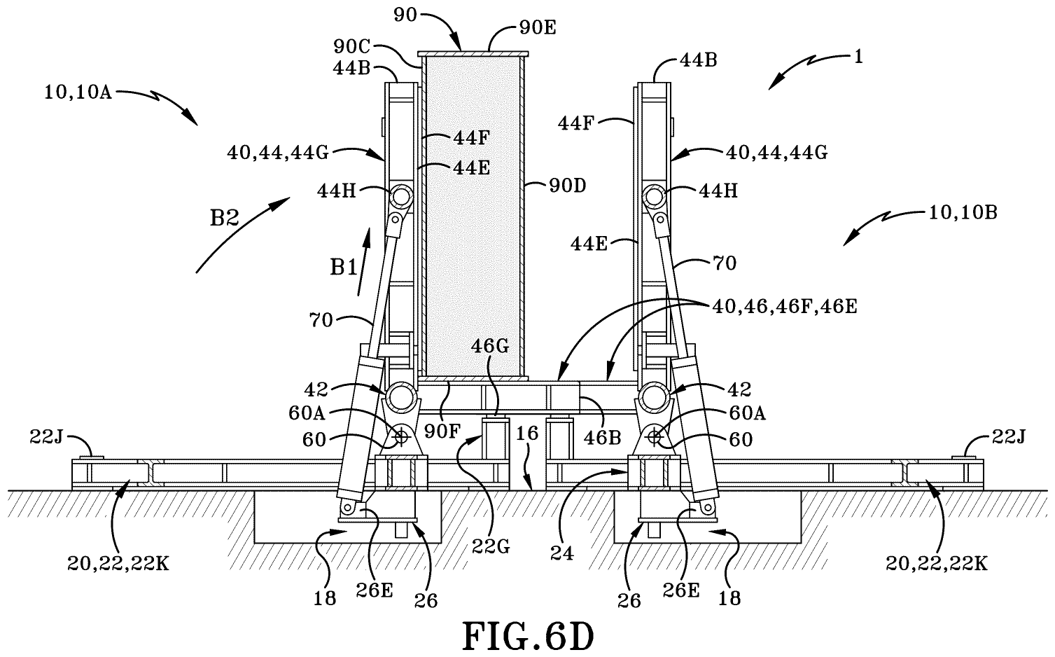

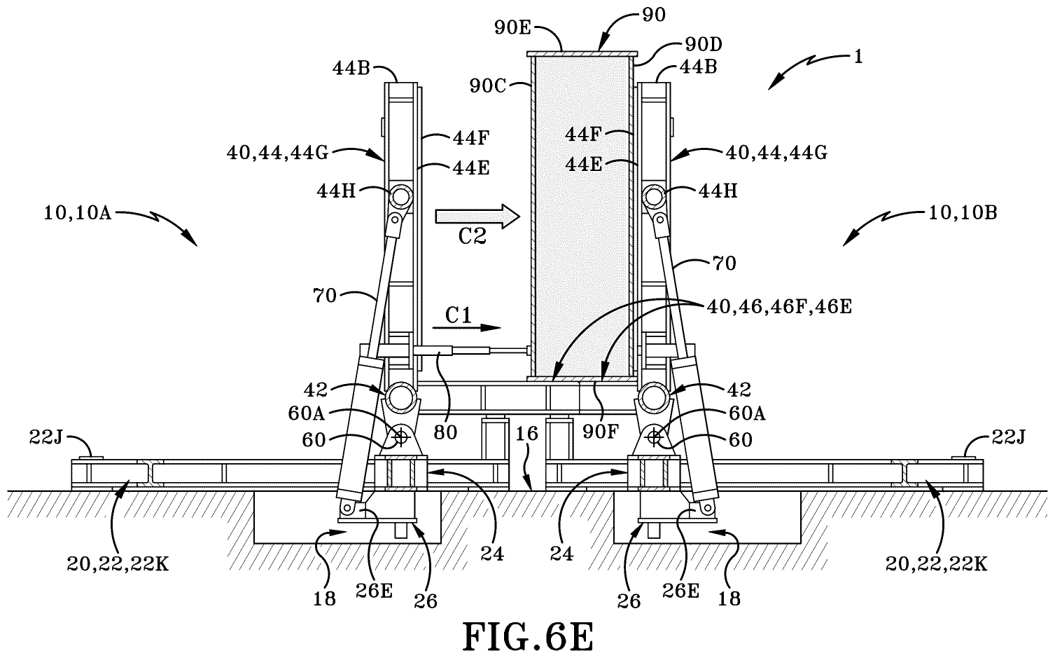

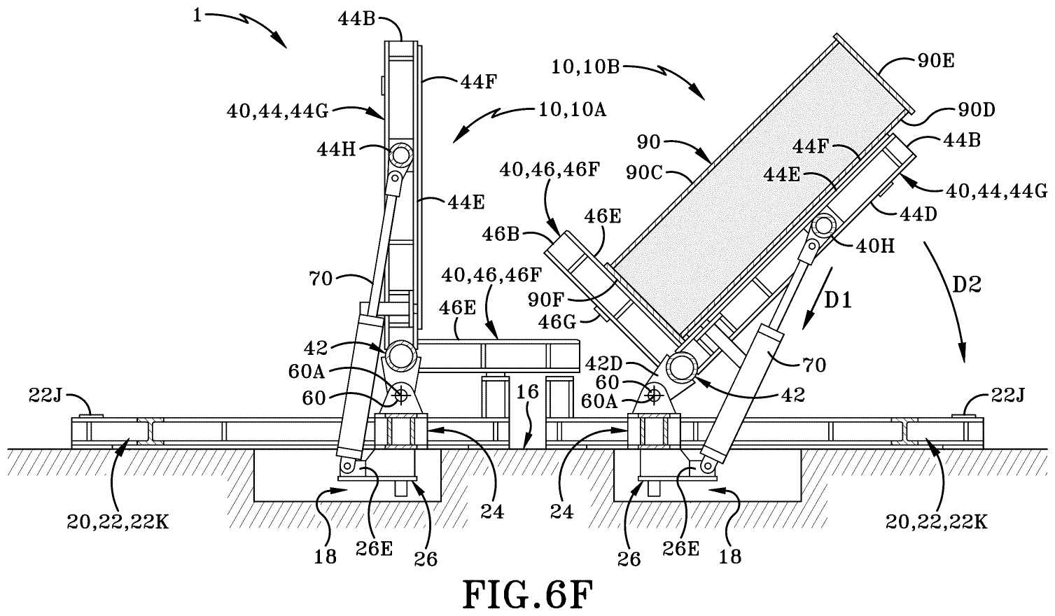

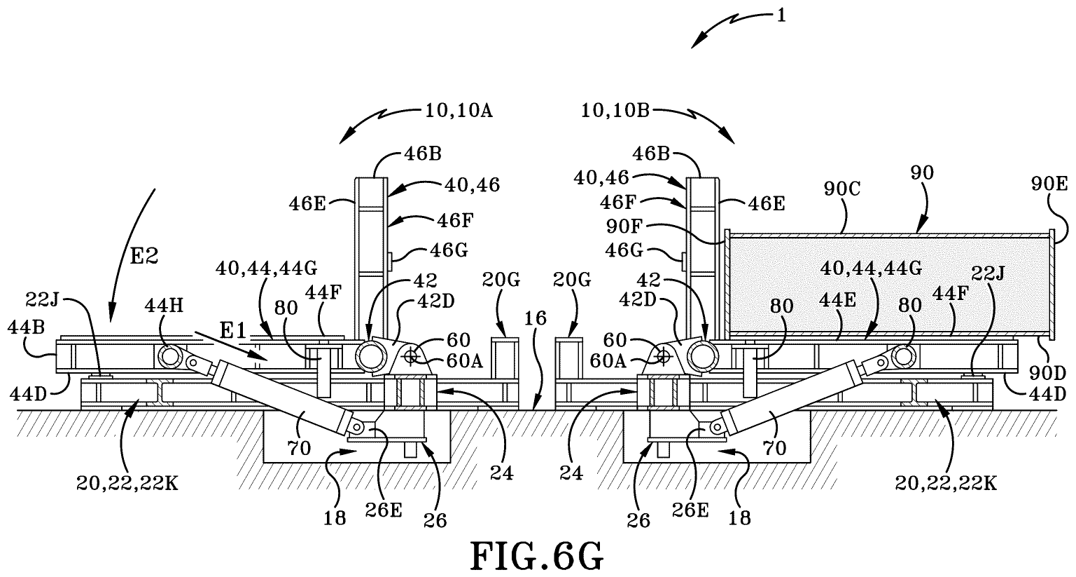

Manipulator 10 also includes a pivot frame 40 that rotatably and/or pivotally engages with the base 20. In operation, the pivot frame 40 may rotate between a seated position (see FIGS. 2-4) and a raised position (see FIGS. 6B and 6D) relative to the base 20 for moving a heavy weldment from a first side or position to a second side or position. Such components and features of the pivot frame 40 are discussed in greater detail below.

Pivot frame 40 includes a pivot bar 42. As best seen in FIG. 2, the pivot bar 42 includes a first end 42A, a second end 42B longitudinally opposite to the first end 42A, and a surrounding wall 42C that extends between the first end 42A and the second end 42B along a longitudinal direction of the pivot bar 42. In the present disclosure, the surrounding wall 42C is generally tubular and/or round between the first end 42A and the second end 42B. In other exemplary embodiments, a surrounding wall of a pivot bar described herein may include any suitable shape or configuration dictated by the implementation of pivot bar 42.

Still referring to pivot bar 42, pivot bar 42 may also include at least extension 42D. As best seen in FIG. 3, pivot bar 42 includes a pair of extensions 42D that extends outwardly from the surrounding wall 42C. In the present disclosure, a first extension of the pair of extensions 42D is positioned at the first end 42A of the pivot bar 42. In the present disclosure, a second extension of the pair of extensions 42D is positioned at the second end 42B of the pivot bar 42. With such arrangement, each extension of the pair of extensions 42D is longitudinally opposite to one another relative to the longitudinal direction of pivot bar 42. Each extension of the pair of extensions 42D is also configured to receive a pivot pin or linkage pin, which is discussed in greater detail below.

Pivot frame 40 also includes a first engagement structure 44 that operably engages with the pivot bar 42. As best seen in FIGS. 2 and 4, the first engagement structure 44 includes an forward end 44A that is spaced apart from the pivot bar 42, a back end 44B that operably engages with the pivot bar 42 and is opposite to the forward end 44A, and a first length 44C measured between the forward end 44A and the back end 44B (see FIG. 4). First engagement structure 44 also includes a first outer surface 44D that extends between the forward end 44A and the back end 44B. First engagement structure 44 also includes a first inner surface 44E that extends between the forward end 44A and the back end 44B and faces in an opposite direction relative to the first outer surface 44D.

Still referring to first engagement structure 44, first engagement structure 44 may also include a guard or cover 44F. As best seen in FIGS. 2 and 4, the cover 44F may operably engage with the first inner surface 44E and extend between the forward end 44A and the back end 44B. In operation, the cover 44F may protect the first inner surface 44E of the first engagement structure 44 when a heavy weldment contacts and engages with the first engagement structure 44 when manipulating the heavy weldment.

Still referring to first engagement structure 44, first engagement structure 44 may also be formed by a set of first beams 44G that extends longitudinally between the forward end 44A and the back end 44B. As best seen in FIG. 3, a first beam of the set of first beams 44G extends longitudinally between the forward end 44A and the back end 44B and operably engages with the pivot bar 42 at the first end 42A. Still referring to FIG. 3, a second beam of the set of first beams 44G extends longitudinally between the forward end 44A and the back end 44B and operably engages with the pivot bar 42 at the second end 42B. Still referring to FIG. 3, a third beam of the set of first beams 44G extends longitudinally between the forward end 44A and the back end 44B and operably engages with the pivot bar 42 between the first end 42A and the second end 42B. In the present disclosure, the third beam of the set of first beams 44G is positioned between the first beam of the set of first beams 44G and the second beam of the set of first beams 44G. In the present disclosure, each beam of the set of first beams 44G also defines the first length 44C. In the present disclosure, the set of first beams 44G also defines the first outer surface 44D and the first inner surface 44E of the first engagement structure 44. In the present disclosure, each beam of the set of first beams 44G also includes the cover 44F.

Still referring to first engagement structure 44, first engagement structure 44 may include a set of tubular supports 44H. As best seen in FIGS. 2-3, a first tubular support of the set of tubular supports 44H operably engages with and is positioned between the first beam and the third beam of the set of first beams 44G. Still referring to FIGS. 2-3, a second tubular support of the set of tubular supports 44H operably engages with and is positioned between the second beam of the set of first beams 44G and the third beam of the set of first beams 44G. Such use of the set of tubular supports 44H may provide axial support for the first engagement structure 44 along a transverse direction of the first engagement structure 44. Such use of the set of tubular supports 44H may also engage a set of pivoting actuators of the manipulator 10 with the pivot frame 40 for pivoting the pivot frame 40 between the seated position and the raised position, which is discussed in greater detail below.

Still referring to first engagement structure 44, first engagement structure 44 may include a set of actuator brackets 44J. As best seen in FIG. 3, a first actuator bracket of the set of actuator brackets 44J may be engaged with the first beam of the set of first beams 44G and is positioned towards the forward end 44A of the first engagement structure 44. Similarly, and as best seen in FIG. 3, a second actuator bracket of the set of actuator brackets 44J may be engaged with the second beam of the set of first beams 44G and is positioned towards the forward end 44A of the first engagement structure 44. Each of the first actuator bracket and the second actuator bracket of the set of actuator brackets 44J is configured to allow a piston of a transfer actuator of the manipulator 10 to pass through the corresponding actuator bracket of the set of actuator brackets 44J for moving a heavy weldment, which is discussed in greater detail below.

Still referring to first engagement structure 44, first engagement structure 44 may also include a set of actuator plates 44L. As best seen in FIGS. 2-3, a first actuator plate of the set of actuator plates 44L extends outwardly from the first tubular support of the set of tubular supports 44H and towards the pivot bar 42. Similarly, a second actuator plate of the set of actuator plates 44L extends outwardly from the second tubular support of the set of tubular supports 44H and towards the pivot bar 42. With such arrangement, each actuator plate of the set of actuator plates 44L is longitudinally opposite to one another relative to first tubular support set of tubular supports 44H and the second tubular support set of tubular supports 44H. Each actuator plate of the set of actuator plates 44L is also configured to receive a pivot pin or rod of a pivot actuator of the manipulator 10, which is discussed in greater detail below.

Pivot frame 40 also includes a second engagement structure 46 that operably engages with the first engagement structure 44. As best seen in FIGS. 2 and 4, the second engagement structure 46 includes a lower end 46A that operably engages with the first engagement structure 44, an upper end 46B and is opposite to the lower end 46A that is spaced apart from the pivot bar 42 and the first engagement structure 44, and a second length 46C that is measured between the lower end 46A and the upper end 46B (see FIG. 4), the second length 46C is also less than the first length 44C of the first engagement structure 44. Second engagement structure 46 also includes a second outer surface 46D that extends between the lower end 46A and the upper end 46B. Second engagement structure 46 also includes a second inner surface 46E that extends between the lower end 46A and the upper end 46B and faces in an opposite direction relative to the second outer surface 46D.

Still referring to second engagement structure 46, second engagement structure 46 may also be formed by a set of second beams 46F that extends vertically between the lower end 46A and the upper end 46B. As best seen in FIG. 4, a first beam of the set of second beams 46F extends vertically between the lower end 46A and the upper end 46B and operably engages with the first beam of the set of first beams 44G of the first engagement structure 44. Still referring to FIG. 3, a second beam of the set of second beams 46F extends vertically between the lower end 46A and the upper end 46B and operably engages with the second beam of the set of first beams 44G of the first engagement structure 44. In the present disclosure, each beam of the set of second beams 46F also defines the second length 46C. In the present disclosure, the set of second beams 46F also includes the second outer surface 46D and the second inner surface 46E of the second engagement structure 46.

Still referring to second engagement structure 46, second engagement structure 46 may also include a guard or cover similar to cover 44F of the first engagement structure 46. If included, the cover of the second engagement structure 46 may operably engage with the second inner surface 46E and extend between the lower end 46A and the upper end 46B. In operation, the cover may protect the second inner surface 46E of the second engagement structure 46 when a heavy weldment contacts and engages with the second engagement structure 46.

Still referring to the second engagement structure 46, the second engagement structure 46G may also include a set of pads or shims 46G that operably engages with the pair of upright supports 22G of the chassis 22. As best seen in FIG. 2, a first pad of the set of pads 46G operably engages with the second outer surface 46D on the first beam of the set of second beams 46F, and a second pad of the set of pads 46G that operably engages with the second outer surface 46D on the second beam of the set of second beams 46F. When the pivot frame 40 is provided in the raised position, the set of pads 46G engages with the pair of upright supports 22G to ensure that the pivot frame 40 is maintained at a desired angle measured relative to the pair of upright supports 22G. In one exemplary embodiment, the set of pads 46G engages with the pair of upright supports 22G to ensure that the second engagement structure 46 of the pivot frame 40 is substantially orthogonal to the pair of upright supports 22G. In another exemplary embodiment, the set of pads 46G may also engage with the pair of upright supports 22G to soften and/or absorb force applied to the pair of upright supports 22G by pivot frame 40 loaded with or without a heavy weldment.

It should be appreciated that while the second engagement structure 46 includes the set of pads or shims 46G, such pads or shims may also be added to other structures or structural members discussed herein. In one exemplary embodiment, pads or shims may be provided with the chassis 22 and the first engagement structure 44 to ensure that the pivot frame 40 is maintained at a desired angle measured relative to the top surface 22E of the chassis 22. In this exemplary embodiment, the pads or shims provided with the chassis 22 and the first engagement structure 44 would engage with one another when the first engagement structure 44 is provided in a seated position (see FIG. 4). As such, the pads or shims provided with the chassis 22 and the first engagement structure 44 ensures that the second engagement structure 46 of the pivot frame 40 is substantially parallel with top surface 22E of the chassis 22.

Pivot frame 40 also defines a pair of central openings 48. As best seen in FIG. 2, the pair of second central openings 46 is collectively defined by the pivot bar 42 and the first engagement structure 44. In operation, a first actuator of the manipulator 10 may pass through a first central opening of the pair of central openings 48 to engage with the first tubular support of the set of tubular supports 44H of the manipulator 10 for pivoting and/or actuating the pivot frame between a seated position and a raised position. Similarly, a second actuator of the manipulator 10 may pass through a second central opening of the pair of central openings 48 to engage with the second tubular support of the set of tubular supports 44H of the manipulator 10 for pivoting and/or actuating the pivot frame between a seated position and a raised position. The pivot actuators and pivot frame of the manipulator 10 are discussed in greater detail below.

It should be understood that the first engagement structure 44 and the second engagement structure 46 may be orientated at any suitable angle relative to one another and/or the pivot bar 42 as dictated by the implementation of the pivot bar 42, including the size, shape, and configuration of a heavy weldment or girder that may be held by pivot bar 42. In the present disclosure, the first engagement structure 44 and the second engagement structure 46 are substantially orthogonal to one another to handle and move a heavy weldment. With such configuration, the first inner surface 44E of the first engagement structure 44 and the second inner surface 46E of the second engagement structure 46 are in operative communication with one another and collectively define a continuous surface.

Manipulator 10 also includes a pair of linkage pins 60 that pivotably engages the pivot frame 40 with the base 20. As best seen in FIG. 3, a first linkage pin of the pair of linkage pins 60 pivotably engages the first extension of the pair of extensions 42D of the pivot bar 42 with the first pivot mount of the pair of pivot mounts 24E of the front cross member 24. With such engagement, the pivot frame 40 is pivotable about a central rotational axis 60A of the first linkage pin of the pair of linkage pins 60 when the pivot frame 40 moves between the seated position and the raised position. Similarly, and as best seen in FIG. 3, the second linkage pin of the pair of linkage pins 60 pivotably engages the second extension of the pair of extensions 42D of the pivot bar 42 with the second pivot mount of the pair of mounts 24E of the front cross member 24. With such engagement, the pivot frame 40 is also pivotable about central rotational axis 60A of the second linkage pin of the pair of linkage pins 60 when the pivot frame 40 moves between the seated position to the raised position. It should be understood that the pair of linkage pins 60 is coaxial with one another when engaged with the base 20 and the pivot frame 40.

Manipulator 10 also includes a pair of pivot actuators 70 that operably engages with the base 20 and the pivot frame 40. As best seen in FIGS. 3 and 4, the pivot actuator 70 pivotably engages with the respective actuator plate of the set of actuator plates 44L of the first engagement structure 44 and pivotably engages with the respective actuator mount 26E of the projection 26 with one another. Once assembled, the pair of pivot actuators 70 may rotate and/or pivot the pivot frame 40 about the rotational axis 60A of the pair of linkage pins 60 to provide the pivot frame 40 at either the seated position or the raised position. In exemplary embodiments, conventional and/or commercially available sensors and other detection devices may be included with the pair of pivot actuators 70 to monitor operation of a corresponding actuator during operation. In one exemplary embodiment, sensors and other detection devices may be provided to monitor the linear movement of a corresponding actuator of the pair of pivot actuators 70 when moving a heavy weldment or girder.

Manipulator 10 also includes a pair of transfer actuators 80 that operably engages with the pivot frame 40. As best seen in FIGS. 2-4, each transfer actuator of the pair of transfer actuator 80 engages with a respective actuator bracket of the set of actuator brackets 44J. Upon assembly, the piston of each transfer actuator of the pair of transfer actuator 80 pass through the respective actuator bracket of the set of actuator brackets 44J and presses against a heavy weldment to move the heavy weldment away from the manipulator 10. In exemplary embodiments, conventional and/or commercially available sensors and other detection devices may be included with the pair of transfer actuators 80 to monitor operation of a corresponding actuator during operation. In one exemplary embodiment, sensors and other detection devices may be provided to monitor the linear movement of a corresponding actuator of the pair of transfer actuators 80 when moving a heavy weldment or girder.

While not illustrated herein, a controller may be operatively engaged with each manipulator 10 of the set of first manipulators 10A and the set of second manipulators 10B to control the actuation of the pairs of pivot actuators 70 and the pairs of transfer actuators 80. The controller may be operated by operators or technicians that are constructing and assembling a heavy weldment on the set of first manipulators 10A and the set of second manipulators 10B. In one instance, one of the operators may initiate actuation of the pairs of pivot actuators 70, via the controller, for manipulating the heavy weldment from a seated or horizontal position to a raised or vertical position (see FIG. 6D). In another instance, one of the operators may also initiate actuation of the pairs of transfer actuators 80, via the controller, for transferring and/or moving the heavy weldment from the set of first manipulators 10A to the set of second manipulators 10B (see FIG. 6D).

Having now discussed the components and features of each manipulator 10 of the manipulator system 1, a method of moving a heavy weldment or girder from a first position to a second position with the manipulator system 1 is discussed in greater detail below.

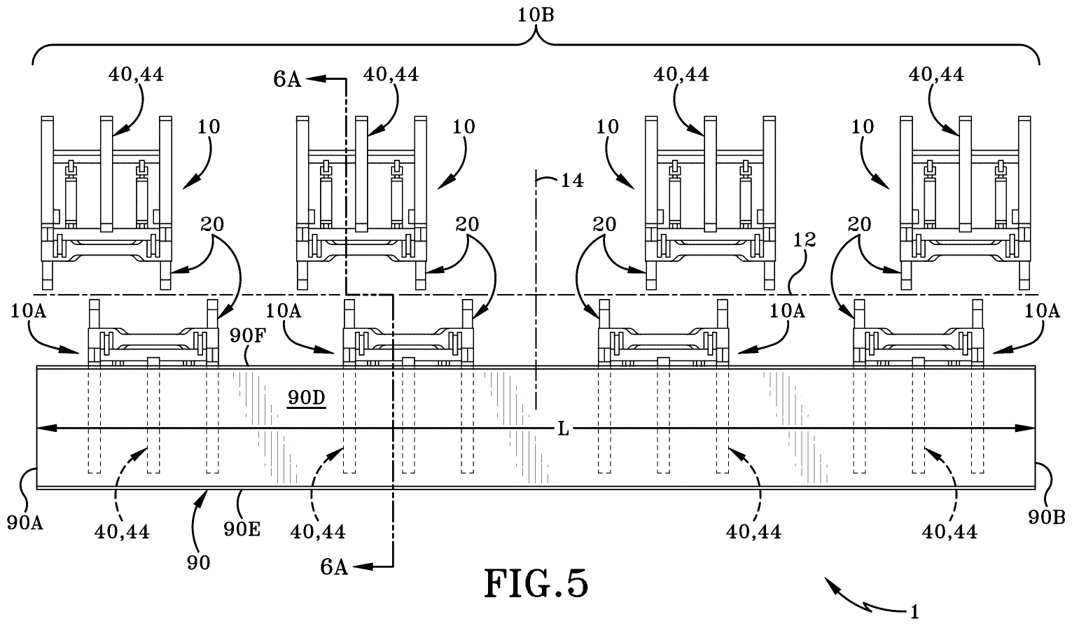

Initially, a heavy weldment 90 may be loaded onto one of the set of first manipulators 10A and the set of second manipulators 10B and be maintained at a first position. As best seen in FIGS. 5-6A, the heavy weldment 90 is loaded onto and maintained at the first position by the set of first manipulators 10A where each manipulator of the set of first manipulators 10 is provided at a first seated position. In the present disclosure, a first end 90A and a second opposing end 90B of the heavy weldment 90 are free from engaging with the manipulator system 1 due to the length of the heavy weldment 90 (denoted by double arrows labeled “L”). First webs or first web stiffeners 90C of the heavy weldment 90 are directly contacting the first engagement structure 44 of each manipulator 10 of the set of first manipulators (see FIG. 6A). In this instance, second webs or second web stiffeners 90D and a top flange 90E are free from engaging with the pivot frame 40 while a bottom flange 90F may engage with at least the first engagement structure 44. It should be noted that the bottom flange 90F may also engage the second engagement structure 46 if desired by operators of the manipulator system 1. Once the operators have performed a suitable number of welds on the heavy weldment 90, one or more operators may begin to rotate the heavy weldment 90 from the first position to a second position that is longitudinally opposite to the first position by actuating the set of first manipulators 10A and the set of second manipulators 10B.

Before lifting and/or raising the heavy weldment 90, an operator may initiate actuation of the set of second manipulators 10B from a second seated position to a second raised position via the pivot actuators 70. As best seen in FIG. 6B, the pivot actuators 70 apply linear force against the pivot frames 40 of the set of second manipulators 10B to rotate the pivot frames 40 from the second seated positions to the second raised positions; the linear force applied by the pivot actuators 70 is denoted by an arrow labeled “A1” in FIG. 6B, and the rotational movement of the pivot frames 40 is denoted by an arrow labeled “A2” in FIG. 6B. Particularly, the piston rods of the pivot actuators 70 apply linear force against the set of tubular supports 44H of the first engagement structures 44 to rotate the pivot frames 40 about the rotational axis 60A of the pair of linkage pins 60. The piston rods of the pivot actuators 70 continue to apply linear force against the set of tubular supports 44H of the first engagement structures 44 until the second engagement structures 46 rests on the chassis 22, particularly the pair of upright supports 22G.

Once the set of second manipulators 10B is provided in the second raised position, the operator may then initiate actuation of the set of first manipulators 10A from the first seated position to a first raised position via the pivot actuators 70 while holding the heavy weldment 90. Similar to the operation in FIG. 6B, the pivot actuators 70 apply linear force against the pivot frames 40 of the set of first manipulators 10A to rotate the pivot frames 40 from the first seated positions to the first raised positions; the linear force applied by the pivot actuators 70 is denoted by an arrow labeled “B1” in FIGS. 6C-6D, and the rotational movement of the pivot frames 40 is denoted by an arrow labeled “B2” in FIGS. 6C-6D. Particularly, the piston rods of the pivot actuators 70 apply linear force against the set of tubular supports 44H of the first engagement structures 44 to rotate the pivot frames 40 about the rotational axis 60A of the pair of linkage pins 60. The piston rods of the pivot actuators 70 continue to apply linear force against the set of tubular supports 44H of the first engagement structures 44 until the second engagement structures 46 rest on the chassis 22, particularly the pair of upright supports 22G (see FIG. 6D).

At this stage, the second engagement structures 46 of the set of first manipulators 10A and the set of second manipulators 10B are coplanar with one another. This structural arrangement between the set of first manipulators 10A and the set of second manipulators 10B is considered advantageous at least because such arrangement provides an even and continuous surface between the set of first manipulators 10A and the set of second manipulators 10B when transferring the heavy weldment 90 from the set of first manipulators 10A to the set of second manipulators 10B. It should be noted that since the set of first manipulators 10A and the set of second manipulators 10B are also longitudinally offset to one another, the second engagement structures 46 of the set of first manipulators 10A and the second engagement structures 46 of the set of second manipulators 10B overlap one another to provide this even and continuous surface.

Once this even and continuous surface is created by the second engagement structures 46 of the set of first manipulators 10A and the second engagement structures 46 of the set of second manipulators 10B, the operator may then initiate actuation of the transfer actuators 80 of the set of first manipulators 10A to linearly press against the first web or first web stiffeners 90C for moving and transferring the heavy weldment 90 from the set of first manipulators 10A to the set of second manipulators 10B; such linear force applied by the transfer actuators 80 of the set of first manipulators 10A is denoted by an arrow labeled “C1” in FIG. 6E, and the linear movement of the heavy weldment 90 moving from the set of first manipulators 10A to the set of second manipulators 10B is denoted by an arrow labeled “C2” in FIG. 6E. Particularly, the pistons of the transfer actuators 80 apply linear force against the first web or first web stiffeners 90C of the heavy weldment 90 near the bottom flange 90F of the heavy weldment 90 to move the heavy weldment 90 from the set of first manipulators 10A to the set of second manipulators 10B. The pistons of the transfer actuators 80 continue to apply linear force against first web or first web stiffeners 90C of the heavy weldment 90 until the bottom flange 90F and a second web or second web stiffeners 90D of the heavy weldment 90 contact and are loaded with the pivot frame 40.

Once loaded, the operator may then actuate the set of second manipulators 10B from the second raised position to the second seated position via the pivot actuators 70. As best seen in FIG. 6F, the pivot actuators 70 apply linear force on the pivot frames 40 of the set of second manipulators 10B to rotate the pivot frames 40 from the second raised positions to the second seated positions; the linear force applied by the pivot actuators 70 is denoted by an arrow labeled “D1” in FIG. 6F, and the rotational movement of the pivot frames 40 is denoted by an arrow labeled “D2” in FIG. 6F. Particularly, the piston rods of the pivot actuators 70 apply linear force on the set of tubular supports 44H of the first engagement structures 44 to rotate the pivot frames 40 about the rotational axis 60A of the pair of linkage pins 60. The piston rods of the pivot actuators 70 continue to apply linear force on the set of tubular supports 44H of the first engagement structures 44 until the second engagement structures 46 rests on the chassis 22, particularly the pairs of stops 22J (see FIG. 6G). At this point, operators may continue welding operations on a second side or position of the heavy weldment 90.

Once the set of second manipulators 10B is provided in the second seated position, the operator may then actuate the set of first manipulators 10A from the first raised position back to the first raised position via the pivot actuators 70. Similar to the operation in FIG. 6F, the pivot actuators 70 apply linear force with the pivot frames 40 of the set of first manipulators 10A to rotate the pivot frames 40 from the first raised positions to the first seated positions; the linear force applied by the pivot actuators 70 is denoted by an arrow labeled “E1” in FIG. 6G, and the rotational movement of the pivot frames 40 is denoted by an arrow labeled “E2” in FIG. 6G. Particularly, the piston rods of the pivot actuators 70 apply linear force on the set of tubular supports 44H of the first engagement structures 44 to rotate the pivot frames 40 about the rotational axis 60A of the pair of linkage pins 60. The piston rods of the pivot actuators 70 continue to apply linear force on the set of tubular supports 44H of the first engagement structures 44 until the second engagement structures 46 rest on the chassis 22, particularly the pairs of stops 22J (see FIG. 6G).

It should be understood that the process of lifting and moving the heavy weldment 90 between the set of first manipulators 10A and the set of second manipulators 10B may be repeated until a suitable number of welds are provided on the heavy weldment 90. It should also be understood that while the heavy weldment 90 was initially loaded on the set of first manipulators 10A, the set of second manipulators 10B may be initially used to load and handle the heavy weldment 90 during welding operations.

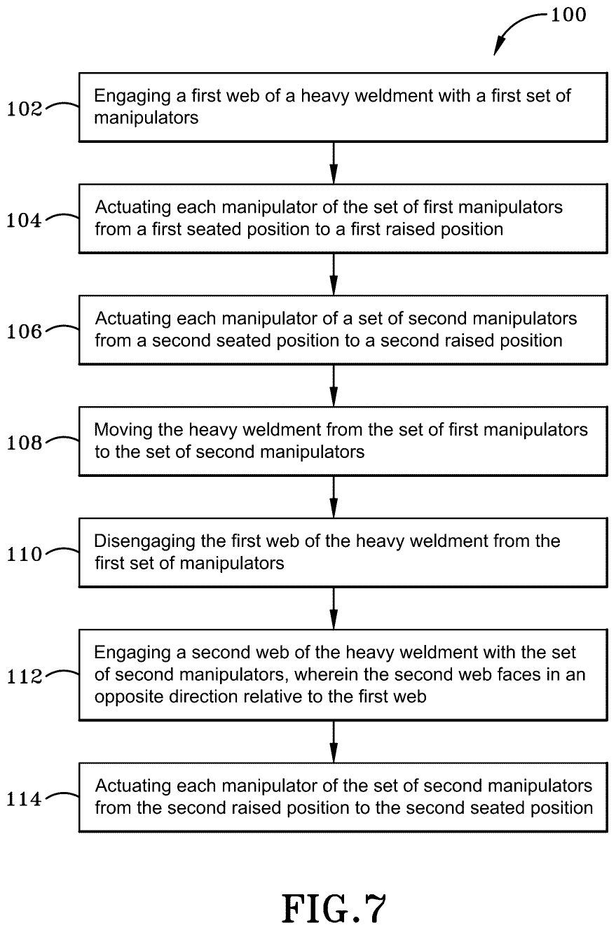

FIG. 7 illustrates a method 100. An initial step 102 of method 100 includes engaging a first web of a heavy weldment with a first set of manipulators. Another step 104 of method 100 includes actuating each manipulator of the set of first manipulators from a first seated position to a first raised position. Another step 106 of method 100 includes actuating each manipulator of a set of second manipulators from a second seated position to a second raised position. Another step 108 of method 100 includes moving the heavy weldment from the set of first manipulators to the set of second manipulators. Another step 110 of method 100 includes disengaging the first web of the heavy weldment from the first set of manipulators. Another step 112 of method 100 includes engaging a second web of the heavy weldment with the set of second manipulators, wherein the second web faces in an opposite direction relative to the first web. Another step 114 of method 100 includes actuating each manipulator of the set of second manipulators from the second raised position to the second seated position.

In other exemplary embodiments, optional and/or additional steps may be included with method 100. In one exemplary embodiment, method 100 may further include that the step of disengaging the first web of the heavy weldment from the first set of manipulator further includes: pressing against the first web of the heavy weldment, by at least one transfer actuator provide with each manipulator of the first set of manipulators, until the second web of the heavy weldment is engaged with the set of second manipulators. In another exemplary embodiment, method 100 may further include that the step of actuating each manipulator of the set of first manipulators from the first seated position to the first raised position further includes: rotating each manipulator of the set of first manipulators in a first direction from the first seated position to the first raised position; and wherein the step of actuating each manipulator of the set of second manipulators from the second seated position to the second raised position further includes: rotating each manipulator of the set of second manipulators in a second direction from the second seated position to the second raised position towards the first set of manipulators. In another exemplary embodiment, method 100 may further include that that step of engaging the first web of the heavy weldment with the first set of manipulators further includes: engaging the first web of the heavy weldment with a first engagement structure of a pivot frame of each manipulator of the set of first manipulators; and engaging at least one flange of the heavy weldment with a second engagement structure of the pivot frame of each manipulator of the set of first manipulators; wherein the first engagement structure and the second engagement structure are substantially orthogonal to the one another. In another exemplary embodiment, method 100 may further include that the step of engaging the second web of the heavy weldment with the second set of manipulators further includes: engaging the second web of the heavy weldment with a first engagement structure of a pivot frame of each manipulator of the set of second manipulators; and engaging the at least one flange of the heavy weldment on a second engagement structure of the pivot frame of each manipulator of the set of second manipulators; wherein the first engagement structure and the second engagement structure are substantially orthogonal to the one another; wherein the first engagement structure of the pivot frame of each manipulator of the set of first manipulators and the set of second manipulators are substantially parallel with one another in the first and second seated positions. In another exemplary embodiment, method 100 may further include steps of defining a continuous surface between the second engagement structure of the pivot frame of each manipulator of the set of first manipulators and the second engagement structure of the pivot frame of each manipulator of the set of second manipulators; and sliding the at least one flange of the heavy weldment along the continuous surface. In another exemplary embodiment, method 100 may further include a step of offsetting the set of first manipulators and the set of second manipulators with one another.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A system for moving a heavy weldment, comprising:
a set of first manipulators longitudinally aligned and spaced apart along a central axis;
a set of second manipulators longitudinally aligned and spaced apart along the central axis and being transversely opposite to the set of first manipulators relative to the central axis;
wherein each manipulator of the set of first manipulators and the set of second manipulators comprises:
a base operably engaged with a ground surface; and
a pivot frame rotatably engaged with the base between a seated position and a raised position, wherein the pivot frame is configured to hold and move the heavy weldment about the central axis.

2. The system of claim 1, wherein the pivot frame of each manipulator of the set of first manipulators and the set of second manipulators further comprises:
a pivot bar;
a first engagement structure operably engaged with the pivot bar; and
a second engagement structure operably engaged with the first engagement structure;
wherein one or both of the first engagement structure and the second engagement structure cooperatively holds the heavy weldment.

3. The system of claim 2, wherein the pivot frame of each manipulator of the set of first manipulators and the set of second manipulators further comprises:
a first end of the first engagement structure;
a second end of the first engagement structure opposite to the first end and engaging with the pivot bar; and
a first inner surface of the first engagement structure extending between the first end and the second end.

4. The system of claim 3, wherein the pivot frame of each manipulator of the set of first manipulators and the set of second manipulators further comprises:
a first end of the second engagement structure;
a second end of the second engagement structure opposite to the first end and engaging with the first engagement structure; and
a second inner surface of the second engagement structure extending between the first end and the second end;
wherein the first inner surface and the second inner surface engage with the heavy weldment and are orthogonal to one another.

5. The system of claim 4, wherein when the pivot frame of each manipulator of one or both of the set of first manipulators and the set of second manipulators is provided in the seated position, the second inner surface is positioned vertically above the first inner surface.

6. The system of claim 4, wherein when the pivot frame of each manipulator of one or both of the set of first manipulators and the set of second manipulators is provided in the raised position, the first inner surface is positioned vertically above the second inner surface.

7. The system of claim 4, wherein when the pivot frame of each manipulator of the set of first manipulators and the set of second manipulators is provided in the raised position, the second inner surfaces of the set of first manipulators and the set of second manipulators are substantially parallel with one another.

8. The system of claim 2, wherein each manipulator of the set of first manipulators and the set of second manipulators further comprises:
at least one pivoting actuator operably engaged with the base and the pivot frame for rotating the pivot frame from the seated position to the raised position.

9. The system of claim 8, wherein the pivot frame of each manipulator of the set of first manipulators and the set of second manipulators further comprises:
at least one tubular support of the first engagement structure that is spaced apart from the pivot bar and engages with the at least one pivoting actuator;
wherein the at least one pivoting actuator is configured to rotate the pivot frame at the at least one tubular support.

10. The system of claim 8, wherein the base of each manipulator of the set of first manipulators and the set of second manipulators further comprises:
at least one projection operably engages with the base and the at least one pivoting actuator and is positioned below the base and the pivot frame.

11. The system of claim 3, wherein each manipulator of the set of first manipulators and the set of second manipulators further comprises:
at least one transfer actuator operably engaged with the pivot frame;
wherein the at least one transfer actuator is configured to linear move the heavy weldment.

12. The system of claim 1, wherein each manipulator of the set of first manipulators and the set of second manipulators further comprises
at least one extension provided with the pivot frame;
at least one pivot mount provided with the base; and
at least one linkage pin connecting the at least one extension and the at least one pivot mount with one another to rotate the pivot frame relative to the base.

13. The system of claim 1, wherein the set of first manipulators and the second set of manipulators are longitudinally offset to one another.

14. A method, comprising:
engaging a first web of a heavy weldment with a first set of manipulators;
actuating each manipulator of the set of first manipulators from a first seated position to a first raised position;
actuating each manipulator of a set of second manipulators from a second seated position to a second raised position;
moving the heavy weldment from the set of first manipulators to the set of second manipulators;
disengaging the first web of the heavy weldment from the first set of manipulators;
engaging a second web of the heavy weldment with the set of second manipulators, wherein the second web faces in an opposite direction relative to the first web; and
actuating each manipulator of the set of second manipulators from the second raised position to the second seated position.

15. The method of claim 14, wherein the step of disengaging the first web of the heavy weldment from the first set of manipulator further includes:
pressing against the first web of the heavy weldment, by at least one transfer actuator provide with each manipulator of the first set of manipulators, until the second web of the heavy weldment is engaged with the set of second manipulators.

16. The method of claim 14, wherein the step of actuating each manipulator of the set of first manipulators from the first seated position to the first raised position further includes:
rotating each manipulator of the set of first manipulators in a first direction from the first seated position to the first raised position; and
wherein the step of actuating each manipulator of the set of second manipulators from the second seated position to the second raised position further includes:
rotating each manipulator of the set of second manipulators in a second direction from the second seated position to the second raised position towards the first set of manipulators.

17. The method of claim 14, wherein the step of engaging the first web of the heavy weldment with the first set of manipulators further includes:
engaging the first web of the heavy weldment with a first engagement structure of a pivot frame of each manipulator of the set of first manipulators; and
engaging at least one flange of the heavy weldment with a second engagement structure of the pivot frame of each manipulator of the set of first manipulators;
wherein the first engagement structure and the second engagement structure are substantially orthogonal to the one another.

18. The method of claim 17, wherein the step of engaging the second web of the heavy weldment with the second set of manipulators further includes:
engaging the second web of the heavy weldment with a first engagement structure of a pivot frame of each manipulator of the set of second manipulators; and
engaging the at least one flange of the heavy weldment on a second engagement structure of the pivot frame of each manipulator of the set of second manipulators;
wherein the first engagement structure and the second engagement structure are substantially orthogonal to the one another;
wherein the first engagement structure of the pivot frame of each manipulator of the set of first manipulators and the set of second manipulators are substantially parallel with one another in the first and second seated positions.

19. The method of claim 18, further comprising:
defining a continuous surface between the second engagement structure of the pivot frame of each manipulator of the set of first manipulators and the second engagement structure of the pivot frame of each manipulator of the set of second manipulators; and
sliding the at least one flange of the heavy weldment along the continuous surface.

20. The method of claim 14, further comprising:
offsetting the set of first manipulators and the set of second manipulators with one another.
